(19) United States
(12) Patent Application Publication
(10) Pub. No.: US 2008/0062306 A1
(43) Pub. Date: Mar. 13, 2008

(54) Moving picture decoding apparatus

(75) Inventors: Hirofumi Mori, Tokyo (JP); Tatsunori Saito, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/633,377

(22) Filed: Dec. 4, 2006

(30) Foreign Application Priority Data
Sep. 8, 2006 (JP) 2006-244549

(51) Int. Cl. H04N 11/04

(52) U.S. Cl. 348/394.1

(57) ABSTRACT

According to an aspect of the invention, there is provided a moving picture decoding apparatus for decoding a coded moving picture signal including a plurality of reference frames having a PTS information indicative of a reproduction time and a frame number information, and a plurality of subordinate frames having a frame number information, comprising: a decoding unit configured to decode the coded moving picture signal and generate a moving picture signal; and a reproduction time calculating unit configured to calculate a reproduction time of the subordinate frame based on a frame number information of a frame to be decoded, and a PTS information of the latest reference frame.

### CROSS-REFERENCE TO RELATED APPLICATIONS

This application is based on and claims the benefit of priority from the prior Japanese Patent Application No. 2006-244549, filed on Sep. 8, 2006; the entire contents of which are incorporated herein by reference.

### BACKGROUND

1. Technical Field

The present invention is related to a moving picture decoding apparatus for receiving an elementary stream and decoding the elementary stream.

2. Related Art

As coding systems of moving pictures, the MPEG (Moving Picture Experts Group)-4, and the H.264/MPEG-4 AVC (will be referred to as “H.264” hereinafter) established by advancing the MPEG-4 have been utilized. More specifically, the H.264 has been employed in the ground wave digital broadcasting service for mobiles in ISBT-T (Integrated Services Digital broadcasting-Terrestrial).

In the ISBT-T, various sorts of media streams such as an elementary stream of H.264 are multiplexed on TS streams (Transport Streams) of MPEG-2 systems. The TS stream is constituted by a TS packet having a fixed length, and error present/absent information within a packet is contained in a header thereof.

When an elementary stream(ES) of the H.264 is multiplexed on a TS stream, a PES (Packetized Elementary Stream) packet is constructed in the unit of one, or more AU (Access Unit), and the PES packet is stored in a payload portion of a TS packet. Since a PES header contains a PTS (Presentation Time Stamp) of a head AU contained in the PES packet, a display time subsequent to the head AU is calculated based upon temporal information contained in SEI (Supplemental Enhancement Information) within a PTS and an ES.

In the wave digital broadcasting service for mobiles, when a fixed frame rate in which time information of SEI is not contained is operated to ES, a moving picture decoding apparatus displays a frame having PTS information on a reproduction time of the PTS information, whereas as to such a frame which does not have both PTS information and time information of SEI, the moving picture decoding apparatus reproduces the frame at intervals “ΔT” with reference to the frame having the PTS information.

### SUMMARY

According to an aspect of the invention, there is provided a moving picture decoding apparatus for decoding a coded moving picture signal including a plurality of reference frames having a PTS information indicative of a reproduction time and a frame number information, and a plurality of subordinate frames having a frame number information, comprising: a decoding unit configured to decode the coded moving picture signal and generate a moving picture signal; and a reproduction time calculating unit configured to calculate a reproduction time of the subordinate frame based on a frame number information of a frame to be decoded, and a PTS information of the latest reference frame.

### BRIEF DESCRIPTION OF THE DRAWINGS

FIG. 1 is an exemplary functional structural diagram of a moving picture processing unit of a moving picture decoding apparatus according.

FIG. 2 is an exemplary flow chart for representing a sequence for decoding coded image information by the moving picture processing unit of the moving picture decoding apparatus.

FIG. 3 is an exemplary diagram for explaining the moving picture decoding apparatus according to a first embodiment.

FIG. 4 is an exemplary diagram for explaining a moving picture decoding apparatus according to a second embodiment.

FIG. 5 is an exemplary flow char for decoding sequence for calculating a reproduction time of a picture by the moving picture processing unit of the moving picture decoding apparatus according to the embodiments.

FIG. 6 is an exemplary another diagram for explaining the moving picture decoding apparatus according to the second embodiment.

### DESCRIPTION OF THE EMBODIMENTS

Various embodiment modes of the present invention will now be described in detail based upon accompanying drawings.

As the moving picture decoding apparatus according to the embodiments, a detailed explanation is made of a moving picture decoding apparatus 1 which receives a decoding image signal “a” employed in a wave digital broadcasting system, and the like, and then, decodes the received coded image signal “a.”

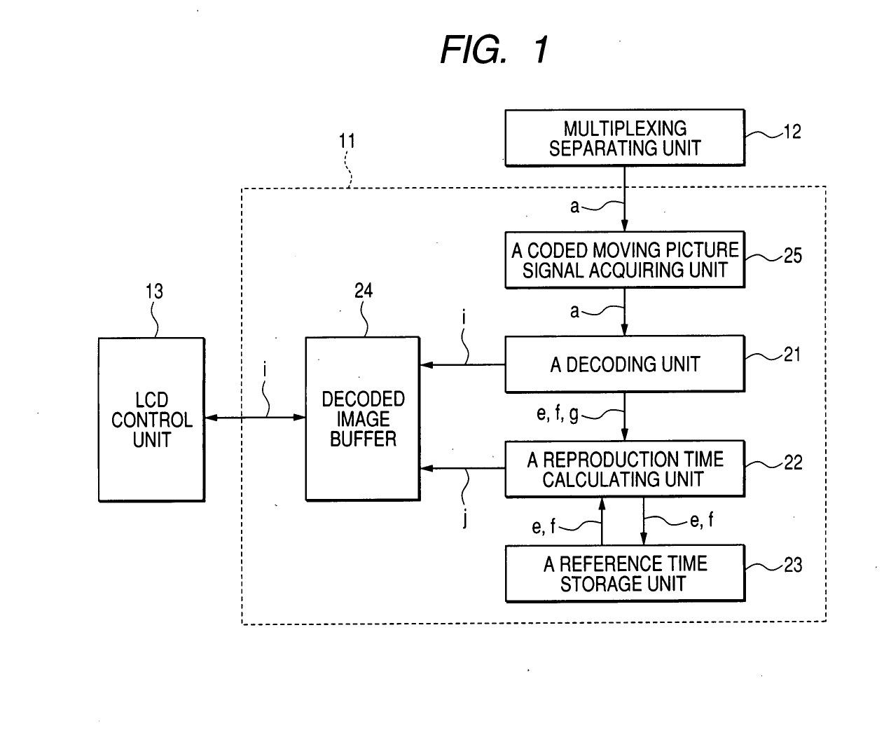

FIG. 1 is a functional structural diagram of a moving picture processing unit 12 of the moving picture decoding apparatus 1.

The moving picture decoding apparatus 1 shown in FIG. 1 is mounted on an information terminal such as a portable telephone and a PDA (Personal Digital Assistant), and performs a decoding operation of a coded moving picture which is acquired by this information terminal.

As shown in FIG. 1, the moving picture processing unit 12 is arranged by a coded moving picture signal acquiring unit 25, a decoding unit 21, a display time calculating unit 22, a reference time storage unit 23, and a decoded image buffer 24. The coded moving picture signal acquiring unit 25 acquires the coded moving picture signal “a” derived from a multiplexing-separating unit 11. The decoding unit 21 decodes the coded moving picture signal “a” so as to produce a moving picture signal “i.” The display time calculating unit 22 calculates a display time of a frame “b” based upon information which is received from the coded moving picture signal acquiring unit 25 via the decoding unit 21. The reference time storage unit 23 stores thereinto PTS information “f” of a reference frame “c” and frame number information “e”, which are contained in the coded moving picture signal “a.” The decoded image buffer 24 stores thereinto a moving picture signal “i” decoded by the decoding unit 21.

Since this coded moving picture signal “a” has contained image information of a plurality of frames “b”, the image information can be recognized as a moving picture by a user when the frames “b” are displayed in a frame feeding mode.

As this coding method, the below-mentioned two sorts of coding methods are employed:

(1) An inter-frame coding method

(2) An intra-frame coding method.

### (1) The Inter-Frame Coding Method:

The inter-frame coding method corresponds to a method for coding a moving picture by employing difference information between a preceding frame “b” and the present frame “b” to be coded.

Typically correlation of a moving picture along a time direction and correlation between frames “b” are high, therefore an information amount can be largely compressed by utilizing a difference between continuous frames “D.”

However, when a content of a moving picture is largely changed, a difference between the preceding frame and the frame to be coded, so that a compression effect of an information amount achieved by the inter-frame coding method can be hardly expected. Also, in the case that an error has been mixed in received coded information, the error is propagated among the frames “b” on the decoding side.

### (2) The Intra-Frame Coding Method:

The intra-frame coding method corresponds to such a coding method which is completed within a frame “b.”

In a continuous sequence, although such a compression effect as explained in the inter-frame coding method cannot be expected in this intra-frame coding method, the intra-frame coding method may be employed in a scene change occurred when image contents of frames “b” are largely changed, or when a refresh is performed.

The above-explained refresh implies that a frame “b” encoded by using the intra-frame coding method is inserted in a periodic manner in order to avoid that an error is propagated between frames “b” (namely, drawback of inter-frame coding method), and this inserted frame “b” constitutes a starting point of the inter-frame coding method. The frame “b” inserted for this refresh purpose is temporarily stored for referring to a difference when the inter-frame coding method is performed, and the preceding frame “b” encoded by using the inter-frame coding method.

Also, in a broadcasting service, when a reception side starts to receive a stream at arbitrary timing, if the reception side starts to receive the frame “b” encoded by using the inter-frame coding method, then such a frame “b” which becomes a starting point of a difference is not present, so that the receiving side cannot decode the frame “b.” Under such a circumstance, while the frame “b” encoded by using the intra-frame coding method is defined as a starting point, frames “b” encoded by using the inter-frame coding method subsequent to the above frame “b” of the starting point are decoded.

When the moving picture decoding apparatus 1 decodes coded information of a moving picture, the moving picture decoding apparatus 1 recognizes identification data of the inter-frame coding method and identification data of the intra-frame coding method, and then, performs a decoding process corresponding to each of these identification data. In the H.264, a plurality of reference frames “c” are utilized when a decoding operation for the frames “b” coded by the inter-frame coding method is carried out, so that these reference frames “c” are stored in the decoded image buffer 24. Then, while the moving picture decoding apparatus 1 refers to these reference frames “c”, the moving picture decoding apparatus 1 decodes the frames “b” coded by the inter-frame coding method.

Also, as a recovering process when an error is mixed in a stream of the H.264, normally, in such a case that an error is mixed in frames “b” coded by the inter-frame coding method, a concealment process operation (recovering process operation) using correlation among the frames “b” is carried out with reference to the reference frame “c.”

In the embodiments, the frames “b” will be explained as follows: That is, frames “b” coded by the intra-frame coding method are explained as reference frames “c”, whereas frames “b” coded by the inter-frame coding method are explained as subordinate frames “d.”

The coded moving picture signal “a” is arranged by enumerating reference frames “c” and subordinate frames “d” in a time sequential manner, which are obtained by coding the frames “b.” A reference frame “c” contains at least frame number information “e”, PTS information “f” indicative of a reproduction time, and fixed time interval information “g” indicative of a reproduction time interval among frames. Also, a subordinate frame “d” contains at least a frame number “e.”

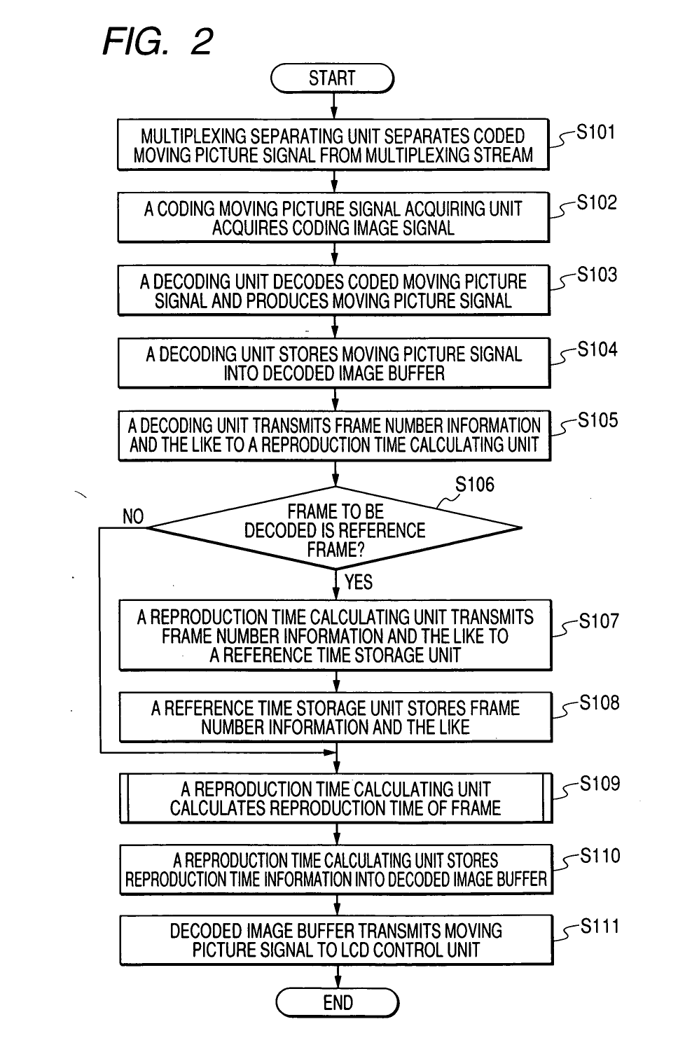

FIG. 2 is an exemplary flow chart for describing a sequential operation in which the moving picture decoding apparatus 1 receives coded moving picture signal information “a” and decodes the received coded moving picture signal “a.”

As indicated in FIG. 2, when the transmitting/receiving circuit unit 18 of the moving picture decoding apparatus 1 receives a multiplexed stream, the multiplexing-separating unit 11 separates this multiplexed stream into an audio stream (voice signal) and a video stream (coding image signal “a”) (step S101).

At this time, the coded moving picture signal “a” contains parameter information such as the reproduction time management information (PTS information) and the frame number information, and error information in addition to image information.

The coded moving picture signal acquiring unit 25 acquires the coded moving picture signal “a” separated by the multiplexing separating unit 11 (step S102) The decoding unit 21 decodes this coded moving picture signal “a” so as to produce a moving picture signal “i” (step S103), and stores this moving picture signal “i” into the decoded image buffer 24 (step S104). Also, the decoding unit 21 transmits the frame number information “e” of the subordinate frame “d”, the frame number information “e” of the reference frame “c”, the PTS information “f”, and the fixed time interval information “g”, and the like to the display time calculating unit 22 (step S105).

The reproduction time calculating unit 22 judges as to whether or not the transmitted frame “b” corresponds to the reference frame “c” (step S106). When the transmitted frame “b” is the reference frame “c” (“YES” in step S106), the reproduction time calculating unit 22 transmits both the PTS information “f” and the frame number information “e” received from the decoding unit 21 to the reference time storage unit 23 (step S107). Also, the reproduction time calculating unit 22 has continuously stored thereinto the fixed time interval information “g” of the latest reference frame “c.”

The reference time storage unit 23 stores thereinto the transmitted PTS information “f” and the transmitted frame number information “e” (step S108) The reference time storage unit 23 has continuously stored thereinto the PTS information “f” and the frame number information “e” as to the latest reference frame “c”, and transmits this PTS information “f” and also this frame number information “e” to the display time calculating unit 22 in response to a request issued from the reproduction time calculating unit 22.

Also, the reproduction time calculating unit 22 calculates a reproduction time of the transmitted frame “b” (step S109), and then, stores reproduction time information “j” of this calculated display time in the decoded image buffer 24 (step S110).

The decoded image buffer 24 transmits a moving picture signal “i” received from the decoding unit 21 to the LCD control unit 13 based upon the reproduction time information “j” received from the reproduction time calculating unit 22 (step S111).

### First Embodiment

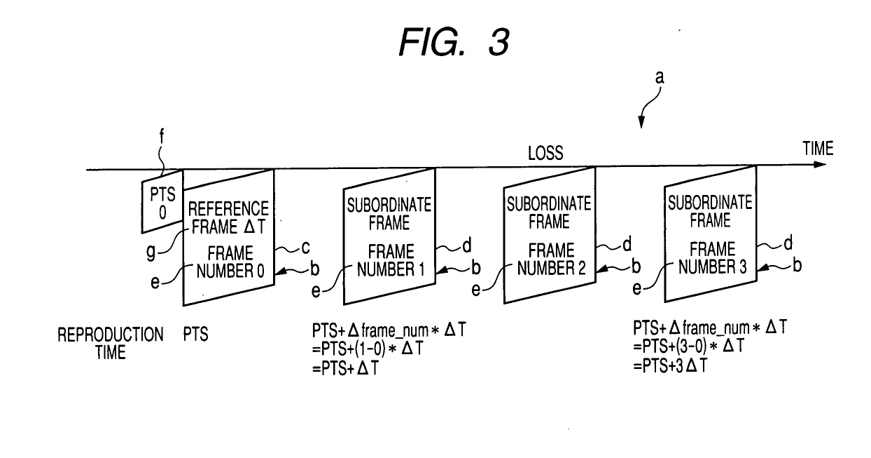

Next, a description is made of such a sequence that the reproduction time calculating unit 22 of the moving picture processing unit 12 employed in the moving picture decoding apparatus 1 calculates a reproduction time of a frame “b” as a first embodiment based upon FIG. 3.

One example will now be explained below: That is, in the coded moving picture signal “a” acquired by the coded moving picture signal acquiring unit 25, although data as to frames “b” having frame numbers “0” and “1” have been acquired under normal condition, data as to a frame “b” having a frame number 2 is dropped, and next, data as to a frame “b” having a frame number 2 is acquired.

The frame “b” having the frame number “0” corresponds to the reference frame “c”, and the frames “b” having the frame numbers 1, 2, 3, 4, . . . , which are continued to this reference frame “c”, correspond to the subordinate frames “d.”

Only the reference frame “c” contains the PTS information “f” and the fixed time interval information “g” indicative of the fixed time interval “ΔT” which corresponds to a fixed time interval for indicating the frame “b.”

In this case, as represented in FIG. 3, a formula for calculating a reproduction time of the subordinate frame “d” is expressed by the formula (1) below:

### [Formula 1]

Reproduction time (frame number)=reference reproduction time+change amount of frame number×fixed time interval ΔT (1)

In the formula (1), “reference reproduction time” indicates a reproduction time which is mainly acquired from the PTS information “c” of the latest reference frame “c”, and is used as a reference when the reproduction time of the subordinate frame “b” is calculated.

The change amount of the frame number corresponds to a difference between the frame number (reference frame number)of the latest reference frame “c” and the relevant frame number.

In the beginning, the reproduction time calculating unit 22 defines the reproduction time contained in the PTS information “f” of the reference frame “c” having the frame number “0” as a reproduction time and a reference display time:

### [Formula 2]

reproduction time (0)=PTS (2)

### [Formula 3]

reference reproduction time=PTS (3)

### Then, the reproduction time calculating unit 22 calculates a reproduction time as to the subordinate frame “d” of the frame number 1 based upon the above-explained formula (1):

$$\begin{matrix}[ Formula 4 ] & \\ \begin{matrix} Reproduction time ( 1 ) = reference reproduction time + \\ change amount of frame number \times \\ Δ T \\ = reference reproduction time + \\ ( 1 - 0 ) \times Δ T \\ = reference reproduction time + Δ T\end{matrix} & ( 4 )\end{matrix}$$

Next, since the frame “b” having the frame number 2 cannot be received, the reproduction time calculating unit 22 calculates a reproduction time of the frame “b” having the frame number 3 by skipping over the frame number 2. The reproduction time of the frame “b” having the frame number 3 is calculated as follows:

$$\begin{matrix}[ Formula 5 ] & \\ \begin{matrix} Reproduction time ( 3 ) = reference reproduction time + \\ change amount of frame number \times \\ Δ T \\ = reference reproduction time + \\ ( 3 - 0 ) \times Δ T \\ = reference reproduction time + 3 Δ T\end{matrix} & ( 5 )\end{matrix}$$

As explained above, since the reproduction times are calculated by using the frame numbers, even when the frame “b” is dropped, the correct reroduction times of the frame “b” can be calculated.

On the other hand, as explained in the related art, in the method for reproducing the continuous frames “b” by merely making the fixed time interval ΔT in the received coded moving picture signal “a”, when one frame “b” is dropped, all of reproduction times of the subsequent frames “b” are shifted, so that qualities of images are largely lowered.

The qualities images of the embodiments may improve the qualities of moving picture is much better than those of the related art.

In accordance with the first embodiment, the reproduction time calculating unit 22 of the moving picture processing unit 12 can correctly calculate the respective frames “b” even in such a case that either one or plural frames “b” in the received coded moving pictured signal “a” are dropped, so that the quality of the moving picture image can be improved.

### Second Embodiment

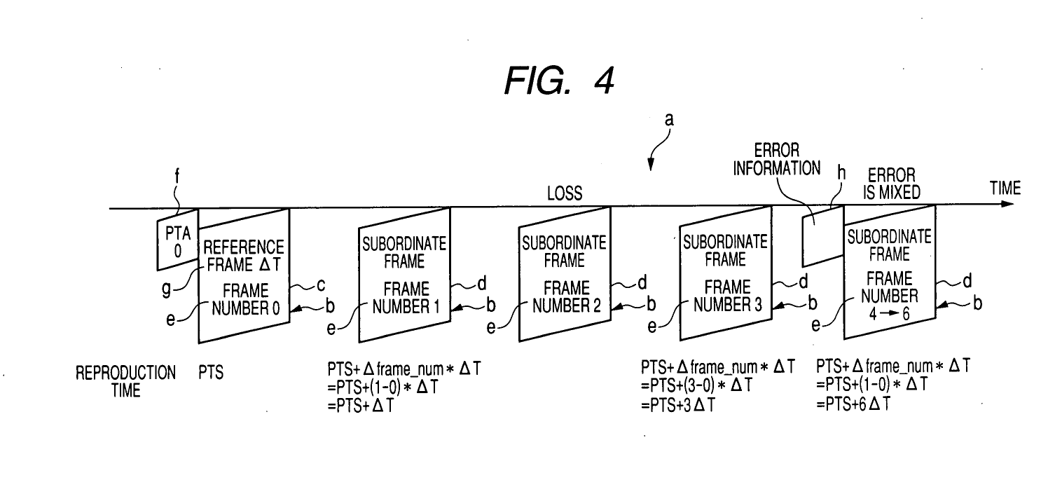

The moving picture decoding apparatus 1 according to a second embodiment will now be explained with reference to FIG. 4 to FIG. 6.

Another example will now be explained below: That is, in the coding image signal “a” acquired by the coded moving picture signal acquiring unit 25, although data as to frames “b” having frame numbers “0” and “1” have been acquired under normal condition, data as to a frame “b” having a frame number 2 is dropped, and next, data as to a frame “b” having a frame number 3 is acquired, and further, an error is mixed in such a manner that a frame number 6 is attached to a frame “b” having a frame number 4.

In this case, as indicated in FIG. 4, error information “h” has been attached to the frame “b” into which the error has been mixed.

As shown in FIG. 4, in the case that the first embodiment is employed in this example, although correct reproduction times are calculated as to the frames “b” having the frame numbers “0”, “1”, and “3”, since the frame number for the frame “b” having the frame number 4 has been attached as “6” due to the error, a reproduction time as to the frame “b” having the frame number 4 is erroneously calculated as follows:

$$\begin{matrix}[ Formula 6 ] & \\ \begin{matrix} Reproduction time ( 4 ) = reference reproduction time + \\ change amount of frame number \times \\ Δ T \\ = reference reproduction time + \\ ( 6 - 0 ) \times Δ T \\ = reference reproduction time + 6 Δ T\end{matrix} & ( 5 )\end{matrix}$$

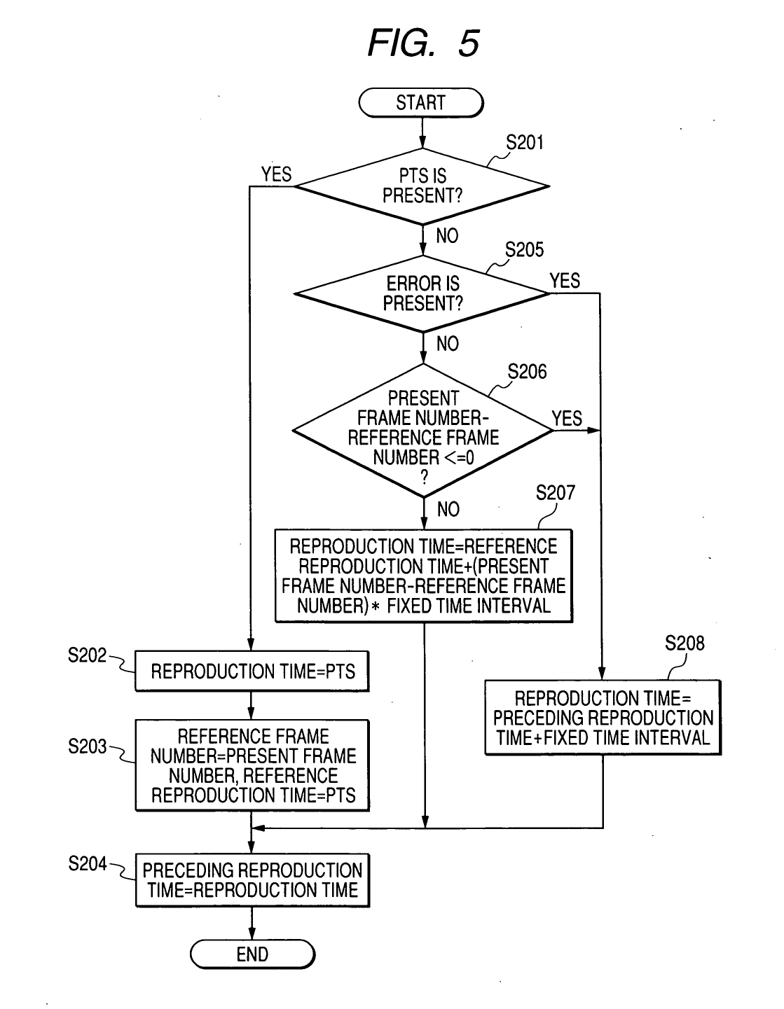

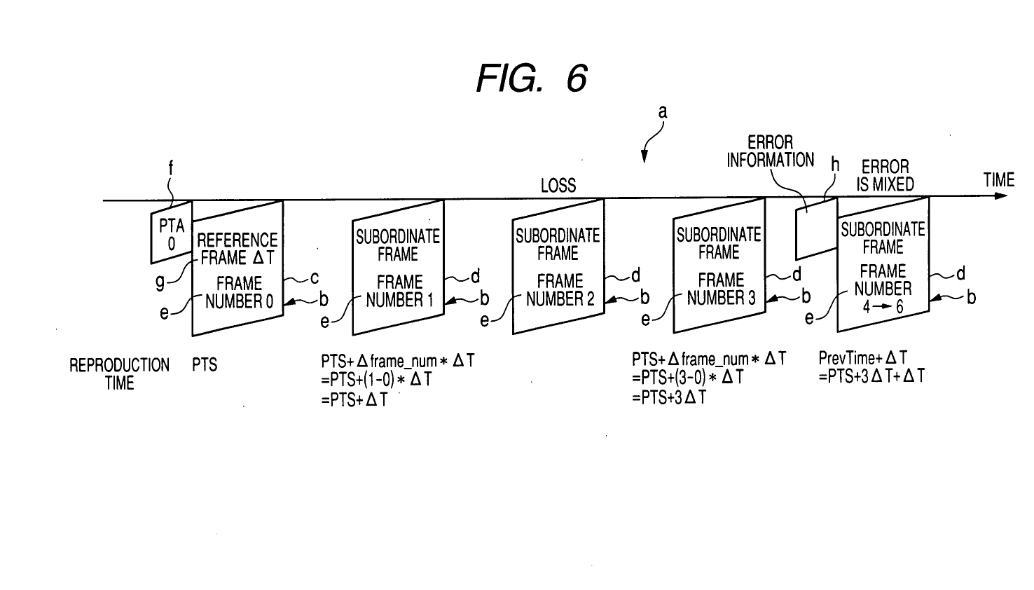

As a consequence, as the second embodiment, a description is made of a calculating process with reference to a flow chart of FIG. 5, and as explanatory diagram of FIG. 6. That is, in the case that one frame “b” is dropped and an error is mixed into another frame “b” in a coded moving picture signal “a”, the reproduction time calculating unit 22 calculates a reproduction time of a frame “b.”

Firstly, as shown in FIG. 5 and FIG. 6, the reproduction time calculating unit 22 judges as to whether or not the image information of the frame “b” contains the PTS information “f” (step S201 corresponding to step S106). In such a case that the image information of the frame “b” contains the PTS information “f” (“YES” of step S201), the reproduction time calculating unit 22 recognizes this frame “b” as the reference frame “c” having the frame number “0”, and calculates a reproduction time as follows (step S202):

### [Formula 7]

Reproduction time (0)=PTS (7)

### Also, the reproduction time calculating unit 22 sets a reference frame number as this frame number (namely, “0” of FIG. 6), and also, sets reference reproduction time as this reproduction time (reproduction time of PTS information “f”) (step S203).

Then, the reproduction time calculating unit 22 sets a preceding reproduction time indicative of a reproduction time of such a frame “b” immediately before the above-described frame “b” to this reproduction time (step S204). It should be understood that this preceding reproduction time is continuously stored in the reproduction time calculating unit 22.

Also, when the image information of the frame “b” does not contain the PTS information (“NO” in step S201), the reproduction time calculating unit 22 judges as to whether or not the image information of the frame “b” contains the error information “h” (step S205).

If the image information of the frame “b” does not contain the error information “h” (“NO” in step S205), the reproduction time calculating unit 22 judges as to whether or not the frame number of this frame “b” is larger than the reference frame number (step S206).

In the case that the frame number of this frame “b” is larger than the reference frame number (“YES” of step S206), the reproduction time calculating unit 22 judges that this frame “b” corresponds to the subordinate frame “d”, and the frame number (“1” in FIG. 6) attached to the image information is correct. As a consequence, the reproduction time calculating unit 22 calculates a reproduction time of this frame “b” by the following formula (f) (step S207):

$$\begin{matrix}[ Formula 8 ] & \\ \begin{matrix} Reproduction time ( 1 ) = reference reproduction time + \\ change amount of frame number \times \\ Δ T \\ = reference reproduction time + \\ ( 1 - 0 ) \times Δ T \\ = reference reproduction time + Δ T\end{matrix} & ( 8 )\end{matrix}$$

### Then, the preceding reproduction time is set to this reproduction time (step S204).

Also, when the image information of the frame “b” contains the error information “h” (“YES” in step S205), and also, when the frame number of the frame “b” is smaller than, or equal to the reference frame number (“NO” in step S106), the reproduction time calculating unit 22 judges that the frame number (“b” of FIG. 7) of the frame “b” is erroneous.

As a consequence, the reproduction time calculating unit 22 calculates a reproduction time of this frame “b” by employing the preceding reproduction time and the below-mentioned reproduction time, while the frame number of this frame “b” is not used (step S208):

### [Formula 9]

Reproduction time (4)=preceding reproduction time+ΔT (9)

### Then, the reproduction time calculating unit 22 sets the preceding reproduction time as this calculated reproduction time (step S204).

According to the second embodiment, the reproduction time calculating unit 22 of the moving picture processing unit 12 can correctly calculate the respective frames “b” even in such a case that either one or plural frames “b” in the received coded moving picture signal “a” are dropped, and furthermore, even in the case that the error is contained in the image information of the frame “b”, so that the image quality of the moving picture image can be improved.

### Translation of Drawings

### FIG. 1

13 LCD control unit;
24 decoded image buffer;
11 multiplexing separating unit;
25 a coded moving picture signal acquiring unit;
21 a decoding unit;
22 a reproduction time calculating unit;
23 a reference time storage unit;

### FIG. 2

A start;
B end;

### Steps:

S101 multiplexing separating unit separates coded moving picture signal from multiplexing stream;
S102 a coding moving picture signal acquiring unit acquires coding image signal;
S103 a decoding unit decodes coded moving picture signal and produces moving picture signal;
S104 a decoding unit stores moving picture signal into decoded image buffer;
S105 a decoding unit transmits frame number information and the like to a reproduction time calculating unit;
S106 frame to be decoded is reference frame?;
S107 a reproduction time calculating unit transmits frame number information and the like to a reference time storage unit;
S108 a reference time storage unit stores frame number information and the like;
S109 a reproduction time calculating unit calculates reproduction time of frame;
S110 a reproduction time calculating unit stores reproduction time information into decoded image buffer;
S111 decoded image buffer transmits moving picture signal to LCD control unit;

### FIG. 3

a reproduction time;
b reference frame;
c frame number;
d subordinate frame;
e time;

### FIG. 4

a reproduction time;
b reference frame;
c frame number;
d subordinate frame;
e time;
f error information;
g error is mixed;

FIG. 5
A start;
B end;

### Steps:

S201 PTS is present?;
S205 error is present?;
S206 present frame number−reference frame number<=0?;
S207 reproduction time=reference reproduction time+(present frame number−reference frame number)*fixed time interval;
S208 reproduction time=preceding reproduction time+fixed time interval;
S202 reproduction time=PTS;
S203 reference frame number=present frame number, reference reproduction time=PTS;
S204 preceding reproduction time=reproduction time;

### FIG. 6

a reproduction time;
b reference frame;
c frame number;
d subordinate frame;
e time;
f error information;
g error is mixed;

What is claimed is:

1. A moving picture decoding apparatus for decoding a coded moving picture signal including a plurality of reference frames having a PTS information indicative of a reproduction time and a frame number information, and a plurality of subordinate frames having a frame number information, comprising:
a decoding unit configured to decode the coded moving picture signal and generate a moving picture signal; and
a reproduction time calculating unit configured to calculate a reproduction time of the subordinate frame based on a frame number information of a frame to be decoded, and a PTS information of the latest reference frame.

2. A moving picture decoding apparatus for decoding a coded moving picture signal including a plurality of reference frames having a PTS information indicative of a reproduction time, a frame number information, and a fixed time interval information indicating an interval of reproduction times between frames, and a plurality of subordinate frames having a frame number information, comprising:
a decoding unit configured to decode the coded moving picture signal and generate a moving picture signal; and
a reproduction time calculating unit configured to calculate a reproduction time of a subordinate frame based on a PTS information of the latest reference frame, the fixed time interval information, and a difference between a frame number information of frame to be decoded and a frame number of the latest reference frame.

3. The moving picture decoding apparatus according to claim 2, wherein
the reproduction time calculating unit continuously stores a preceding reproduction time information indicative of a reproduction time of an immediately before frame; and
wherein, in case that an error information is added to a next frame, the reproduction time calculating unit calculates a reproduction time based on the preceding reproduction time and the fixed time interval information of the latest reference frame.

4. The moving picture decoding apparatus according to claim 1, further comprising;
a decoded image buffer configured to store the reproduction time of the subordinate frame and the moving picture signal decoded, and configured to output the moving picture signal based on the reproduction time of the subordinate frame.

5. A moving picture decoding apparatus, comprising:
a receiving unit configured to receive coded moving picture signal including an intra-coded frame and an inter-coded frame;
a decoding unit configured to decode the coded moving image signal and generate a moving image signal; and
a reproduction time generating unit configured to generate a reproduction time to be used for reproducing the inter-coded frame.

6. The moving picture decoding apparatus according to claim 5, wherein the intra-coded frame contains presentation time information to be used for reproducing the intra-coded frame, and the reproduction time generating unit calculates the reproduction time based on the presentation time information and the frame number between the inter-coded frame and the intra-coded frame.

7. The moving picture decoding apparatus according to claim 5, wherein the intra-coded frame contains presentation time information to be used for reproducing the intra-coded frame, and the reproduction time generating unit calculates the reproduction time based on the presentation time information extracted from the intra-coded frame and the frame number between the inter-coded frame to be reproduced ant the intra-coded frame.

8. The moving picture decoding apparatus according to claim 5, further comprising:
a decoded image buffer configured to store the moving picture signal and the reproduction time to be used for reproducing the inter-coded frame and the intra-coded frame.

9. The moving picture decoding apparatus according to claim 8, wherein the decoded image buffer stores the moving picture signal obtained by decoding the intra-coded frame and inter-coded frame.

10. The moving picture decoding apparatus according to 5, the reproduction time generating unit calculates the reproduction time when the inter-coded frame contains error information.
